(19) United States
(12) Patent Application Publication
(10) Pub. No.: US 2013/0325992 A1
(43) Pub. Date: Dec. 5, 2013

(54) METHODS AND APPARATUS FOR DETERMINING OUTCOMES OF ON-LINE CONVERSATIONS AND SIMILAR DISCOURSES THROUGH ANALYSIS OF EXPRESSIONS OF SENTIMENT DURING THE CONVERSATIONS

(71) Applicant: Solariat, Inc., San Francisco, CA (US)

(72) Inventors: Conor McGann, San Carlos, CA (US); Mariya Orshansky, Austin, TX (US)

(73) Assignee: Solariat, Inc., San Francisco, CA (US)

(21) Appl. No.: 13/964,073

(22) Filed: Aug. 10, 2013

Related U.S. Application Data
(63) Continuation-in-part of application No. 13/529,547, filed on Jun. 21, 2012, now Pat. No. 8,521,818.
Application No. 13/529,547 is a continuation-in-part of application No. 13/040,092, filed on Mar. 3, 2011, now Pat. No. 8,271,583.
Application No. 13/040,092 is a continuation of application No. 12/851,489, filed on Aug. 5, 2010, now Pat. No. 7,921,156.

(51) Int. Cl. H04L 12/58

(52) U.S. Cl. CPC H04L 51/046
USPC 709/206

(57) ABSTRACT

Systems and methods for automatically analyzing on-line conversations or similar discourses among individuals and determining through such analyses outcomes of the conversations as evidenced, for example, by expressions of sentiment during the conversation. Sentiments are derived from analyses of intentions of a user as expressed in an on-line conversation or other user generated content (UGC). These intentions are identified and subsequently acted upon, for example by making others aware of the conversation and suggesting possible responses to the UGC. The intention signals derived from the UGC may also be used to fashion or update a user profile or inform a broader view of the individual associated with the UGC.

### RELATED APPLICATIONS

This is a CONTINUATION-IN-PART of U.S. patent application Ser. No. 13/529,547, filed Jun. 21, 2012, which is a CONTINUATION-IN-PART of U.S. patent application Ser. No. 13/040,092, filed Mar. 03, 2011, now U.S. Pat. No. 8,271,583, which is a CONTINUATION of U.S. patent application Ser. No. 12/851,489, filed Aug. 5, 2010, now U.S. Pat. No. 7,921,156, each of which is assigned to the assignee of the present invention and incorporated herein by reference.

### FIELD OF THE INVENTION

The present invention relates to methods and systems for automatically analyzing on-line conversations or similar discourses among individuals and determining through such analyses outcomes of the conversations as evidenced, for example, by expressions of sentiment and intention during the conversation.

### BACKGROUND

In recent years, websites featuring user-generated content (UGC), that is content created and posted to websites by end-users, have become increasingly popular. UGC accounts for a wide variety of content, including news, gossip, audio-video productions, photography and social commentary. Content of this sort may be presented in any of a variety of forms, including web logs (blogs), comments regarding website editor-created content (e.g., user reviews of products being offered for sale at a website), status updates on social networking sites, and question and answer databases commonly known as forums.

Companies were quick to recognize the potential power of the Web as it concerns access to potential consumers of goods and services and many different Web-based advertising models have been implemented. More recently, companies have attempted to interact directly with consumers via the Web and some have launched on-line forums in which consumers can communicate directly with service representatives. In some respects, these on-line venues are similar to call centers in which customer service personnel interact with consumers in an attempt to address complaints, provide answers or offer other information regarding a company's products and/or services. Alternatively, or in addition, company representatives may monitor consumer-oriented forums and insert themselves into on-line conversations concerning the company's products and/or services.

### SUMMARY OF THE INVENTION

In various embodiments, the present invention provides systems and methods for automatically analyzing on-line conversations or similar discourses among individuals and determining through such analyses outcomes of the conversations as evidenced, for example, by expressions of sentiment during the conversation. These and other examples of the features and uses of the present invention are described further below.

### BRIEF DESCRIPTION OF THE DRAWINGS

The present invention is illustrated by way of example, and not limitation, in the figures of the accompanying drawings in which:

FIG. 1 illustrates components of a network in which embodiments of the present invention may be implemented;

FIG. 2 illustrates an example of a process for determining creatives for insertion within a conversation in accordance with embodiments of the present invention;

FIG. 3 illustrates an example of a process for determining intention topics of utterances in accordance with embodiments of the present invention;

FIG. 4 illustrates an example of a creative for insertion in a conversation in accordance with embodiments of the present invention;

FIG. 5 illustrates a conversation state diagram according to an embodiment of the present invention;

FIG. 6A illustrates components of a computer system in which computer readable instructions instantiating the methods of the present invention may be stored and executed; and

FIG. 6B illustrates a software architecture for various ones of the computer systems illustrated in FIG. 1.

### DETAILED DESCRIPTION

Described herein are methods and systems for automatically analyzing on-line conversations or similar discourses among individuals and determining through such analyses outcomes of the conversations as evidenced, for example, by expressions of sentiment during the conversation. The present methods and systems may find application in analysis of an on-line conversation or other UGC hosted on a social media or other website, or an instant message (IM) or similar conversation, Twitter™ tweets, social network page commentary, e-mail threads, forum-hosted discussion boards, etc., or similar environment, e.g., individual postings to social networking sites, blogs, tweets, etc., or even transcripts of live conversations between two or more people (or a single individual and an automated interactive voice response system), and subsequently acting upon same, for example by determining the outcome of said conversation or discourse and evaluating the effectiveness of a customer service organization or individual.

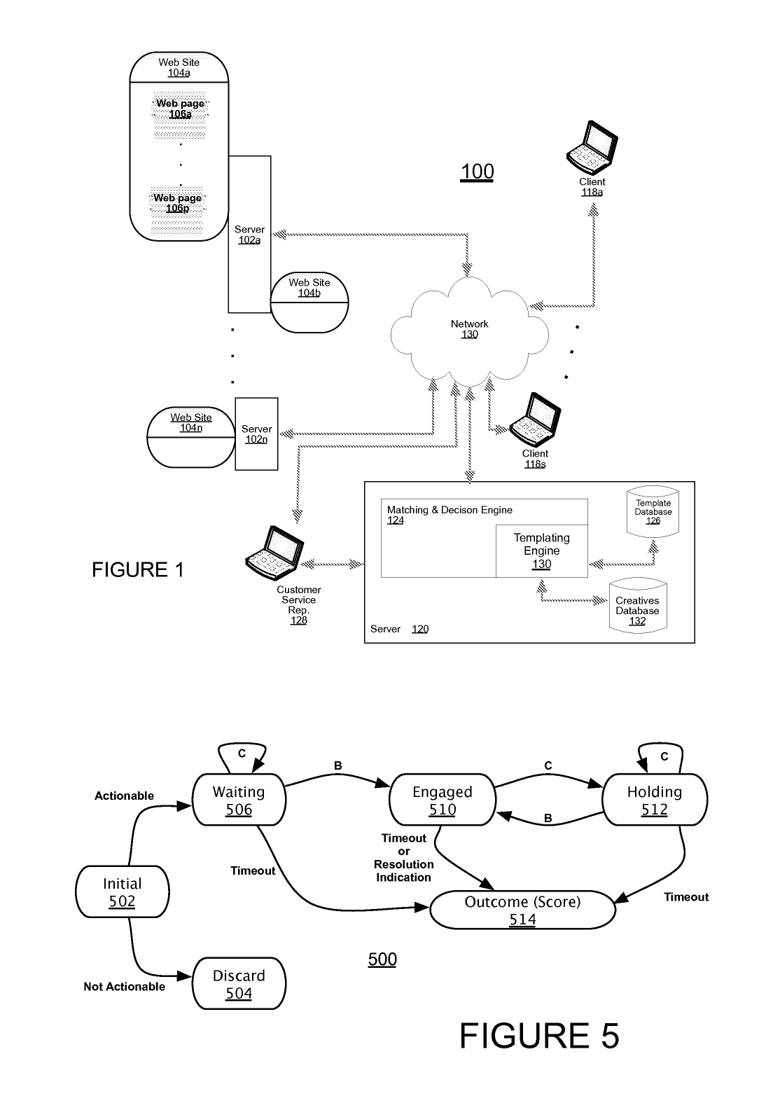

To better understand the environment within which the present methods and systems operate, consider the network 100 illustrated in FIG. 1. Included in this network are various servers 102a-102n, each hosting one or more Web sites 104a -104n. Each Web site 104 may include one or more Web pages 106a-106p. The Web sites may be forum sites (such as customer services pages or forums hosted by or for an enterprise), social media sites in which users are engaged in some sort of on-line social conversation with other users, or any other sites at which UGC is posted (e.g., in the form of an on-line conversation, solitary post, or otherwise). Hence, the Web pages may be forum pages, blogs, social network sites, chat windows, product or other review pages, audio/video posting/hosting sites, photo posting/sharing sites, etc.

Users access the Web sites via client systems 118a-118s. The client systems may, in some cases, be computer systems, such as personal computers or the like, but more generally may be any computer-based or processor-based device that executes application software which allows the content of the Web site to be rendered for display to the user on a display device. For example, client systems may include computer systems, mobile devices such as iPads™, smart phones, mobile phones, etc., and the application software may be Web browser software such as Microsoft Corporation's Internet Explorer™, Apple Inc.'s Safari™, or Google Inc.'s Chrome™, or instant messaging software such as Apple Inc.'s iChat™, America Online Inc.'s AIM™, etc. In some instances, dedicated applications (or “apps”) running on mobile computing platforms (such as tablet computers, smart phones, etc.) may be employed. Such apps often provide improved user experiences in the context of associated web sites and portals than those afforded through the use of web browser applications as they make use of dedicated application programming interfaces (APIs) for the associated websites. Any or all of the above-described applications are typically stored in one or more tangible computer readable storage devices accessible to one or more processors of the subject client system and, when executed, cause the processor(s) to perform the operations necessary to render the subject sites/pages for display at the subject system (e.g., via a display device communicatively coupled to the processor). The various constituents of network 100 are communicatively coupled to one another via one or more computer/data networks 130, which may include the Internet and other networks coupled thereto. The precise nature of network 130 is not critical to the present invention.

Network 100 also includes server 120, which hosts a matching and decision engine 124. The matching and decision engine implements an embodiment of the present invention, however, in other embodiments the function of this engine may be instantiated in multiple distributed entities. Accordingly, the embodiment illustrated in FIG. 1 should be regarded as merely a convenient example for purposes of the following discussion and not as a limitation of the present invention.

Matching and decision engine 124 is configured for the automatic detection of UGC posted at a subject Web site 104 and the subsequent automated determination of any actionable user intention (with respect to a product or service, for example) expressed within that UGC. That determination of user intention may then trigger one or more actions, including bringing the UGC (which may be an invitation to initiate a conversation or a solitary posting) to the attention of others (e.g., an advertiser or the advertiser's proxy, or combinations thereof) to facilitate a reply (e.g., with one or more comments or links to content deemed to be relevant to the subject of the UGC and/or to the user), and/or integrating this intention signal with other information known about the user in a user profile, which itself may form one basis for subsequent conversations with or advertisements directed to the user. The recognition of actionable user intention expressed within UGC may thus act as a triggering event for a conversation, as described in greater detail below.

In one example, the actionable intention may be the recognition of a need of the user, e.g., a need for a particular product or service, or perhaps a need for information concerning a particular subject, or a complaint regarding a product or service. The matching and decision engine 124 may determine a set (and here a set may be one or more) of candidate creatives to present to the poster of the UGC by way of insertion into the on-line conversation present on the Web site. These creatives may be obtained from creatives database 132 and automatically inserted into the conversation, for example where they are intended to serve as responses to the comments. In a situation where the original post was determined to be a need for product information, for example, the creative may be one or more hyperlinks to Web pages that include such information and which are believed to be helpful for the user and/or others engaged in the conversation (e.g., users associated with client systems 118a-118s) to explore (e.g., via selection of hyperlinks included in the creatives). Server 120 may automatically insert such creatives in the conversation.

In other situations, however, the creatives may be suggested responses for use by a customer service representative when responding to the original user's post. Such responses may be those deemed to be contextually appropriate (e.g., an apology where the original post was determined to be a complaint). In such circumstances, human customer service representatives 128 may filter or refine creatives proposed by the matching and decision engine 124 to modify same in ways deemed well-suited for presentation in the context of the conversation.

Creatives may be fashioned using templates and, in one embodiment of the invention, a library of templates is stored in and obtained from a templates database 126, which is communicatively coupled to the matching and decision engine. This templates database may be hosted at the same or a different server than the matching and decision engine. Matching and decision engine 124 may be configured to provide not just a single “best” matching creative for a subject posting or other UGC element received or obtained from an on-line conversation (and here a conversation may be simply a posting by a single individual and not a two- or multi-way dialog among two or more individuals). Instead, in some cases, the matching and decision engine may be configured to provide a number of creatives deemed relevant to a point in the conversation (e.g., responsive to the actionable intention determined to exist within a posting or an entire thread). Thus the matching and decision engine may deliver one or more creatives assessed to be the most suitable from an available pool of creatives (including, in some cases, creatives that are established or created in real time in response to the UGC). In some cases, no creative will be delivered, for example where the matching and decision engine fails to identify a truly actionable intention or where an actionable intention is identified but is deemed not to be suitable for response by way of delivering a creative. These assessments involve determining an intention type and topic (e.g., to at least a predetermined confidence level), evaluating the actionability of the intention topic and selecting one or more creatives for presentation (and/or deciding not to present a creative), for example on the basis of relevance scores of the creatives computed with respect to the determined intention type and topic.

In still further cases, the server 120 may respond to UGC at a Web page 106 with a reply selected by matching and decision engine 124 without need for a human customer service representative to be involved. For example, where the original post is determined to be an expression of a positive user experience with a product (e.g., “I really like this new laptop.”), the matching and decision engine may determine an appropriate response (e.g., “Thanks very much.”) and post same immediately. In other words, where the matching a decision engine determines that an original post can be handled in an expeditious fashion without need for further intervention by a customer service representative, the matching and decision engine can take such action. In other instances, all or selected ones of the matching and decision engine posts may be reviewed by a human operator before they are allowed to post to the subject Web site.

Creatives (or other content) may be delivered in accordance with a template retrieved from a template database 126. Selection of an appropriate template is handled by a templating engine 130 (which in some embodiments may be included as part of the matching and decision engine) and may depend upon particulars of the UGC post, as discussed further below. Templates may include fields for content extracted from the UGC, from the creative, and/or from other sources (e.g., a landing page deemed relevant to or for a conversation).

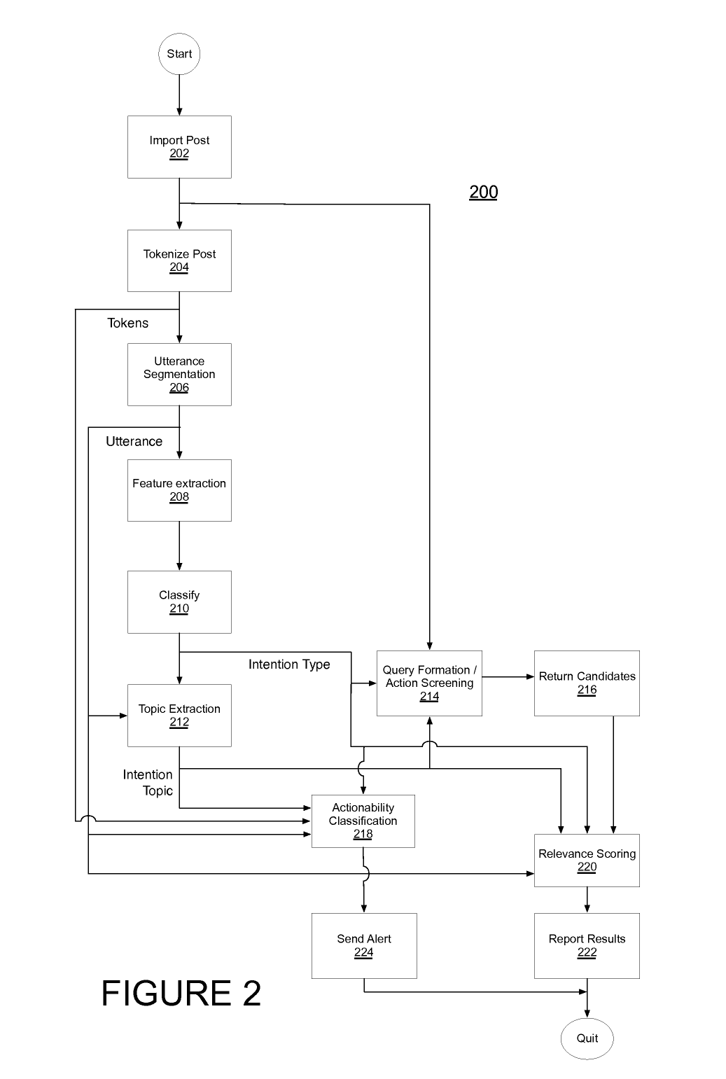

FIG. 2 illustrates aspects of an assessment process 200 for determining an actionable intention from UGC and selecting one or more creatives in response thereto. Note, the selection of creatives is optional in the present invention and some embodiments will include only the portions of the process illustrated in FIG. 2 that encompass the determination of actionable intention within UGC. Further, this illustration is intended only as one example of an implementation of the present invention and should not be viewed as the sole means for same. In other embodiments, steps in process 200 may be performed in parallel and/or in different sequences for matters of convenience or to take advantage of distributed or increased processing capacity and resources. In response to determining an actionable intention in UGC, actions such as alerting others to the existence and/or content of the UGC (e.g., to initiate a conversation) and updating user profiles on the basis of the determined actionable intention may be undertaken. These and other activities are described in greater detail below.

Process 200 begins with a post being received 202 at, or harvested by, server 120. By “post” we mean any form of UGC, including but not limited to, posts or updates to a social media site (whether as part of a multi-participant conversation or otherwise), tweets, postings on blogs, forums, and the like, comments made at third party Web sites, etc. The posts may be received and/or harvested in real time and/or in accordance with a schedule determined by an operator of server 120 and/or customers of such operator.

Once obtained, the post is tokenized 204. Tokenizing breaks the string of text that makes up the post into words, phrases, symbols, or other meaningful elements (tokens). This can be regarded as segregating the post into “words”; however, the term words should be read broadly and is not intended to indicate that all tokens are actually equivalent to the familiar linguistic units commonly understood as words.

Once tokenized, the post is subjected to utterance segmentation 206. In this step, the various phrases in a post are divided up into discrete utterances (also known as speech acts). For example, a post such as:
“My dog won best in show today! He beat out several others. I must remember to stop at the store and pick up his favorite dog food as a reward.”
   may be divided into several utterances, as follows:
“My dog won best in show today!”
“He beat out several others.”
“I must remember to stop at the store and pick up his favorite dog food as a reward.”
   In one embodiment, utterances are determined and segmented based upon the presence of punctuation marks commonly employed with sentence construction (e.g., periods, question marks, exclamation points, etc.). In other examples, single sentences may be segmented into more than one utterance (e.g., based on the presence of one or more demarcation features). Utterances may include questions, assertions, complaints, requests for action, and so on.

Utterance segmentation is not mandatory, but it is preferred. Some posts may contain multiple different thoughts, expressions, etc., and so trying to determine an appropriate set of one or more creatives for response can be difficult unless the post is segmented into utterances. By segmenting a post into utterances, better overall results (in terms of the quality of the creative(s) delivered to the user making the post) can be achieved.

Once the post has been segmented into utterances (if such segmentation is employed), feature extraction 208 can take place. Feature extraction may be accomplished using machine learning, heuristics or other techniques to represent the utterance in vector form. In one example, we use a bag of words representation model whereby each position in the vector is associated with a word token and the value at a given position in the vector represents the importance of the associated token within the utterance. Importance can be measured in several different ways, including, but not limited to tf-idf models.

When generating the vector representation of a given utterance, a service provider may choose to weight word tokens within a post title more strongly than words that occur in the post body. It is also often advisable to use normalized vectors when generating similarity scores between vectors.

The output of the feature extraction process is a feature vector, which is applied as an input to a classifier 210. The classifier examines the feature vector to produce an intention type according to various rule sets. Intention types (which are determined on a per-utterance basis) may include questions, needs, problems, likes/dislikes, check-ins, etc.

Once the intention type information is determined, the utterance undergoes topic extraction 212 to determine intention topics. In part, this process determines a measure of confidence that the extracted topic is the actual topic of interest, for example a key noun phrase. Topic extraction is a linguistics-based approach (rather than a pure keyword matching with sliding window technique) to identifying key noun phrases in the utterances. These key noun phrases are deemed to be the topic of the intention expressed in the utterance. For example, in the utterance, “I want stickers for my laptop”, the specified intention (or intention type) is an expression of desire (want), and the topic of that expressed desire is stickers (not a laptop). A keyword-based approach may have difficulty distinguishing between the stickers or the laptop as the true intention topic of the utterance. By relying on a linguistics-based approach rather than a mere keyword-based approach, however, the present method ensures that the true intention topic (stickers) is correctly identified more often than not.

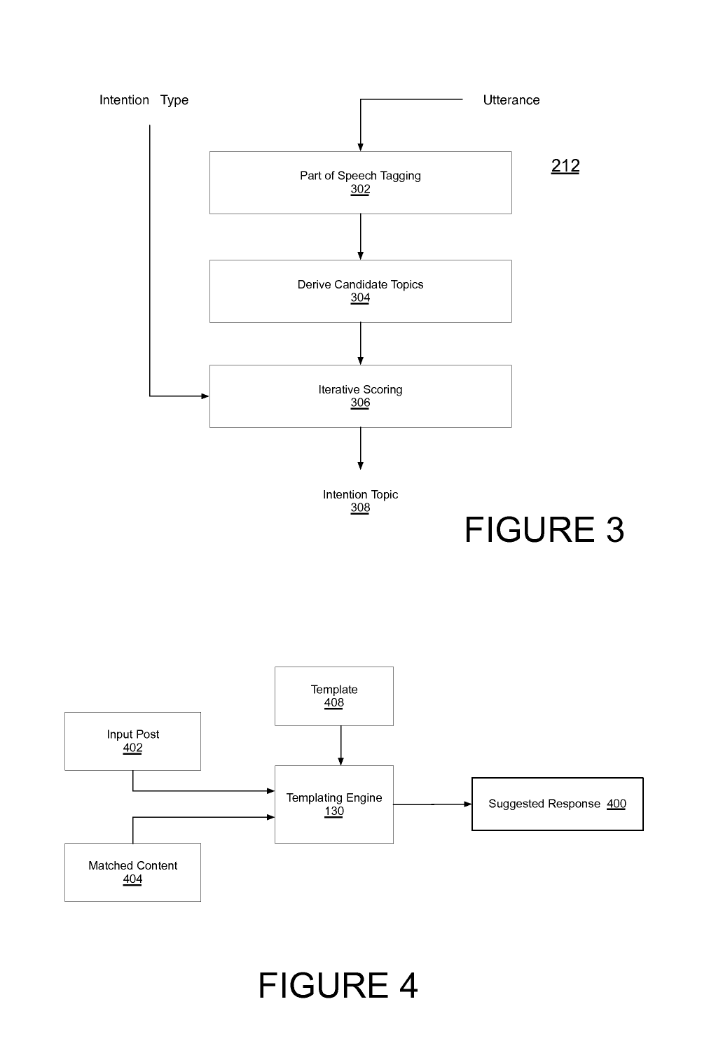

The topic extraction process 212 is discussed in greater detail with reference to FIG. 3. The utterance is provided to a tagging process 302 in which parts of speech elements in the utterance are tagged. The tagged utterance is then analyzed to derive candidate topics 304. This may involve using an engine that applies natural language rules to the tagged parts of speech (thus performing what is essentially a pattern matching function) to derive candidate topics. The candidate topics may be any length n-grams. These possible topics are then scored, according to intention type, in an iterative process 306, the output of which is that one of the possible intention topics is deemed to be the most likely intention topic 308 for the subject utterance.

The scoring procedure may start with heuristics-based scoring of the candidate topics produced at step 304. Then, the intention type information from the classifier can be leveraged to refine the score. For example, by knowing the intention type of an utterance, a defined rule set for the subject utterance can be employed to identify and match common word patterns (at the level of parts of speech) for that intention type as a way to boost the scores of certain candidate topics.

Returning to FIG. 2, the intention type and intention topic along with the original post are provided to a query formulation process 214. Here, a search is developed and made for possible creatives to return in response to the post. The search may be performed against a database of creatives, such as database 132, and the output will be a set of candidate creatives 216. In cases where action(s) other than the return of creatives is desired, a search may be made over databases including the relevant items appropriate for the deserted action(s). For example, where one desired action is transmission of an alert to one or more persons, the search may be made over one or more databases including profiles of individuals to be notified in the event specified intention types/topics are identified. The candidate creatives are scored 220 and the result(s) is (are) reported 222 as matches—i.e., the creative(s) deemed most relevant to the original post, as measured by its (their) relevance to the intention topic of that post.

In parallel, the intention type, topic, tokenized post and original post are provided to an actionability classification procedure 218 to determine whether or not the intention topic is actionable. By actionable we mean an intention topic that is worthy of taking action, or for which it is permissible to do so (e.g., in the form of returning a creative, initiating a conversation, etc.). The actionability determination is then used to send alerts 224, as needed. For example, if a post is identified as being actionable, an alert may be provided to a customer service representative indicating that the post is awaiting a reply. The reply may make use of one or more candidate creatives that were scored as being particularly relevant to or appropriate for the subject of the original post.

The present process of determining matching creatives for a subject post thus involves much more than merely determining sentiment (as is done in other processes). Understanding sentiment alone is typically an insufficient basis on which to take action (e.g., by responding with a creative). For example, sentiment may reveal information about a like or dislike of a person making a post, but it (alone) says nothing about that individual's needs, wants, check-ins (e.g., location-based intentions), etc. Stated differently, sentiment is not the same as actionable intention information.

FIG. 4 illustrates in further detail the procedure by which a suggested response (e.g., creative) 400 is produced by the templating engine 130. As indicated above, the original post 402 and the matched content (e.g., the candidate creatives) 404 are provided to the templating engine, which fashions the response according to a template 408 obtained from the template database. For example, if the original post is determined to be a statement of a problem, a template for a response fashioned, in part, as an apology may be selected. The content to be added to that template is then derived, in part, from the post (e.g., the name of the poster, the name of the produce with which he/she is having problems, etc.) and the candidate creative, and overall suggested response provided to the customer service representative for delivery. As was discussed above, in some cases the suggested response is simply sent as a reply to the original post, e.g., where further conversation is not necessary.

By analyzing the contents of sites such as Web pages, forums and other forms of social media then, systems configured in accordance with the present invention are able to determine actionable intentions of users of the sites and recommend or even take contextually relevant actions (such as, for example, inserting links and associated text at appropriate points in a conversation, directing users to other on-line material that may be helpful to them, alerting others to the existence and/or content of the conversation, updating or constructing user profiles, etc.). To maximize the relevance of these actions to users, these systems are preferably designed to detect and respond to important conversational indicators, such as particular intention types and topics expressed within an online posting. By matching the intention type and topics presented by an author against a set of potential actions, the present systems can select and take those actions most relevant to the authored post. For example, a query directive could be linked to content that provides either a direct answer to the question being asked, or to other material that may be helpful. In other instances, a number of links to content whose tenor, tone and meaning are determined to be relevant (and perhaps useful) in the context of the conversation may be presented.

In the discussion above we use the term “creative” to designate that portion of the content being inserted into the conversation which is intended for presentation to the conversation participants and/or others (i.e., intended to be viewed by them), but this should not be read as restricting the present invention solely to means for inserting commercial content. By creatives, we mean a broader construct, which may include some combination of links or other direction-aiding materials, text, audio and/or visual elements. Creatives may be portions of larger constructs, which we refer to as “payloads”. A payload may include content in addition to a creative, which other content is not itself intended for display to conversation participants or others, but which may be used to direct placement of the creative within a Web page, to gather statistics from the Web page, or provide for or perform another function. For example, a payload may include computer-readable instructions or computer-interpretable tags or other information. Payloads may also include instructions to a customer service representative as to how to conduct an on-line conversation with a particular user. The instructions may be based on user profile information and/or predicted sentiment based on analysis of the UGC posted to the Web page. In some instances, a creative will be the sole constituent of a payload, but this is not necessarily so.

If creatives are to be provided for display, the decision and matching engine passes the creatives (or links to same) to the subject takeoff site, where the creatives are displayed near (i.e., in a contextually relevant location for) the original post. For example, the creatives may be displayed next in order in the conversation thread or may be displayed alongside the conversation thread so as not to be disruptive thereto. This may be accomplished through the use of instructions included with the creative in the payload, code injected into the takeoff page, or by code in a software application, which code or instructions direct the placement of the creatives from server 120.

The present invention thus determines, for a given message (or group of messages) in a conversation, one or more contextually meaningful creatives whose contents, taken together, are relevant for the contents of the original message (or group of messages). If there is a sufficiently strong match, that creative may be provided for display (e.g., in a contextually relevant location with respect to the original message) or suggested for use by a human customer service representative, thereby providing a recommendation to the people engaged in or monitoring the conversation of additional content that can enhance their conversational experience.

The matching procedure described above provides a method for selecting relevant creatives based on textual data available from the Web sites and templates. This process may be enhanced to take into account other information, for example feedback available from usage logs that track user interaction with the creatives, such as mouse overs or clicks, and/or subsequent user actions, such as product purchases or page visits. That is, an adaptive component that takes into account user behavior can be added to the above-described matching procedure by, for example, altering the score of a candidate creative depending on the click through response it has received in the past or other user behavior of interest.

The foregoing discussion highlights the ability of the present system to provide customer service representatives or system operators with “conversational strategies”—that is, strategies for content insertions in conversations. Different creatives can be used within one or more conversational contexts and the results monitored to determine which is the best set of creative content for a particular conversation theme. Stated differently, the present infrastructure allows a determination of a solution to the question, which creative content is best for a given conversation.

Other problem constructs may involve determining the best time to insert a creative into a conversation. For example, analysis of the results of inserting creatives into conversations of varying conversational velocity (or into one conversation under conditions of different conversational velocity) may reveal information that allows service providers to chose optimum or near optimum times to insert future creatives so as to maximize the likelihood that a positive outcome for the conversation will result.

The sum of the results from these kinds of learning instances (facilitated by the above-described infrastructure) gives rise to conversational strategies. Stated differently, the present invention provides means for determining what content to use, when best to insert it in a conversation, and a host of other information relative to conducting on-line conversations.

Turning now to FIG. 5, a state diagram 500 reflecting the handling of an on-line or other conversation is illustrated. When a new post is detected, the conversation may be regarded as being in an initial state 502. While in that state, the post is analyzed in accordance with the above-described procedures to determine whether it includes actionable intentions or not. If the post is not one that includes actionable intentions, the conversation is discarded 504, otherwise, if the post is determined to express an actionable intention, the conversation enters a waiting state 506. In some instances, newly detected posts may not trigger conversation state transitions. For example, if, during the waiting state, the contact (C) that initiated the original post makes a further post, the second post is detected and analyzed, but because the conversation is already in a state awaiting a response from the entity monitoring the site, the conversation state does not change. That is, for the period of time that the conversation is in the waiting state the initiative is with the enterprise that is monitoring the site for posts. For convenience, we will refer to that entity as the “brand” (B), but readers should recognize that this entity could be an advertiser, a proxy or agent for an advertiser, or any other entity that is charged with responding to posts of interest.

As the conversation enters each new state, a check is made to determine whether the conversation should be deemed complete. This may be determined based on the content of the conversation as determined from the above-described analysis. For example, if the analysis reveals that one or both parties to the conversation have posted words indicating they consider the conversation to be over, the conversation may be deemed completed. Alternatively, or in addition, termination of a conversation may be based on a timer event which, in the context of the conversation history and the ending state may be used to estimate whether the conversation has terminated and in what final state is should be. In either (any) instance, the outcome of the conversation will be determined 514, as discussed further below.

If the substance of the conversation posts is not determinative or does not indicate an intention to terminate the conversation, a check may be made to determine the elapsed time since the last post. While the conversation is in the waiting state, the period of time that the brand may be afforded to respond to a post may vary depending on the industry, the site and/or other factors, but if the brand does not respond within a designated timeout period, the post may be considered a “missed call”, and the conversation terminated. An analysis of such situations may be provided to the brand so that customer service training and/or revisions to the kinds of alert mechanisms used to identify new posts requiring attention can be performed in an effort to avoid future missed calls.

Provided the timeout period has not elapsed, when the brand B responds to the original post (e.g., perhaps using a suggested creative, as discussed above) the conversation enters an engaged state 510. While in this state, it is expected that the brand and the contact will converse with one another through an exchange of posts. Each time the contact posts, the conversation enters a holding state 512 (e.g., with the contact awaiting a response from the brand), until the brand responds and the conversation reverts to the engaged state. Brand responses may be live and/or automated (in whole or in part), for example using suggestions provided by the above-described process for selecting creatives. Each post by a contact may be analyzed in the fashion discussed above until either there are no further responses from the contact—indicative of a “dropped call”, or the conversation is deemed to be complete (e.g., upon an indication from the brand that the conversation is over/resolved).

A completed conversation may be analyzed and/or scored to determine and/or indicate its outcome as positive, negative or indeterminate. For example, a positive outcome may be deemed to be the outcome of a conversation that results in a score greater than a first threshold. Examples of conversations that end in positive outcomes may include those in which a problem identified in an original post is ultimately resolved or those in which a contact's wants are satisfied. This may be determined through an analysis of sentiments expressed in the posts by the contact and/or the brand. For example, if an initial post by a contact was determined to include an expression of displeasure (e.g., “I hate the way my laptop crashes!”) and a final post from the contact was an expression of gratitude (e.g., “Thank you.”), a reasonable interpretation of the conversation as a whole might be that the contact's problem had been resolved and that it should be deemed a conversation with a positive outcome.

A negative outcome may be deemed to be anything other than a positive outcome or, in other embodiments, a conversation where no resolution of a problem was reached, etc. More generally, conversations with negative outcomes may be those conversations that failed to achieve an end score at least as high as a minimum threshold value. That is, conversations may be given an initial score (based on an analysis of an initial post), and that score may be revised either at the end of the conversation or periodically during the conversation. In this context, scores may be assigned according to analysis of the posts that comprise the conversation. For example, posts that reflect a negative brand affinity (e.g., a contact's displeasure with the brand) may receive negative or low scores, while those that demonstrate positive brand affinity may receive positive or high scores. An aggregate score, either as a running score during a conversation or a difference between an ending score and an initial score (or any other aggregate score) may be used as a means to evaluate the overall conversation and assign an outcome.

Indeterminate conversation outcomes may be indicative of those conversations where outcomes cannot be determined to a satisfactory confidence level or those where a contact's problem could not be solved but the contact expressed appreciation for the attempt. More generally, indeterminate conversations may be conversations that score more than a minimum value below which the conversation would be deemed to have a negative outcome but which is still insufficient for the conversation to be deemed to have a positive outcome. Of course, other business rules defining outcome determinations can be implemented and the foregoing are offered merely as examples of such possible rules. In some instances, conversations may simply be rated according to a particular scale (e.g., 0-5 stars) and not otherwise categorized as positive, negative or indeterminate.

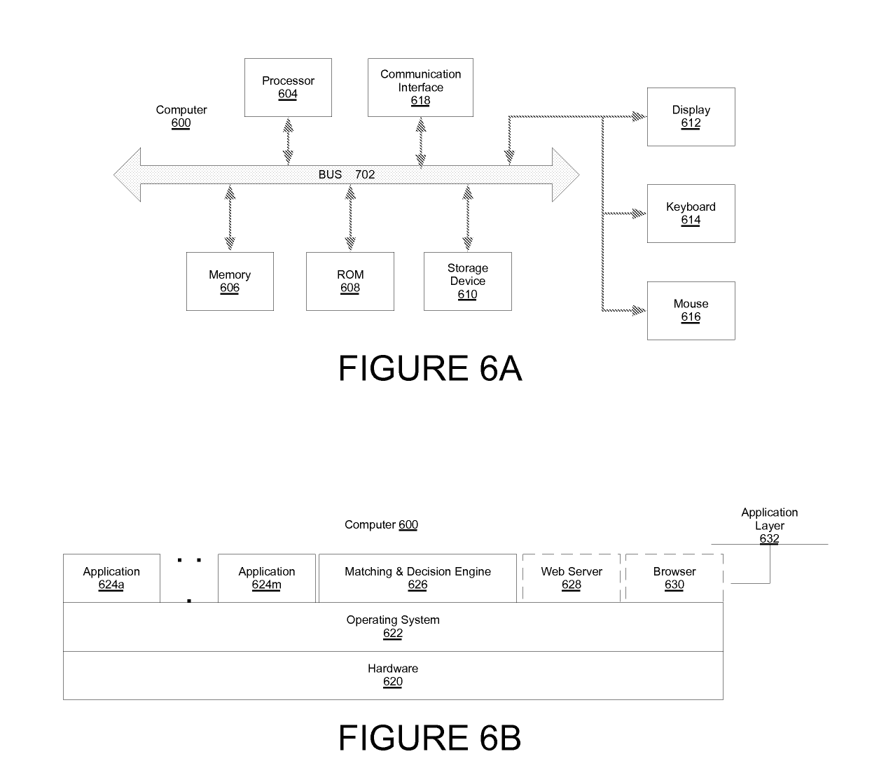

As is apparent from the foregoing discussion, aspects of the present invention involve the use of various computer systems and computer readable storage media having computer-readable instructions stored thereon. FIG. 6A provides an example of a computer system 600 that is representative of any of the servers or client systems discussed herein. Note, not all of the various computer systems may have all of the features of computer system 600. For example, certain of the servers discussed above may not include a display inasmuch as the display function may be provided by a client computer communicatively coupled to the server. Such details are not critical to the present invention. Computer systems such as computer system 600 may be referred to by other names, for example as hand-held devices, mobile devices, smart phones, multiprocessor systems, microprocessor-based electronic devices, digital signal processor-based devices, networked computer systems, minicomputers, mainframe computers, personal computers, servers, laptop computers, tablet computers, and the like. Such labels are not critical to the present invention.

Computer system 600 includes a bus 602 or other communication mechanism for communicating information, and a processor 604 coupled with the bus 602 for processing information. Computer system 600 also includes a main memory 606, such as a random access memory (RAM) or other dynamic storage device, coupled to the bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to the bus 602 for storing static information and instructions for the processor 604. A storage device 610, which may be one or more of a floppy disk, a flexible disk, a hard disk, flash memory-based storage medium, magnetic tape or other magnetic storage medium, a compact disk (CD)-ROM, a digital versatile disk (DVD)-ROM, or other optical storage medium, or any other storage medium from which processor 604 can read, is provided and coupled to the bus 602 for storing information and instructions (e.g., operating systems, applications programs and the like).

Computer system 600 may be coupled via the bus 602 to a display 612, such as a flat panel display, for displaying information to a computer user. An input device 614, such as a keyboard including alphanumeric and other keys, is coupled to the bus 602 for communicating information and command selections to the processor 604. Another type of user input device is cursor control device 616, such as a mouse, a trackball, or cursor direction keys for communicating direction information and command selections to processor 604 and for controlling cursor movement on the display 612. Other user interface devices, such as microphones, speakers, etc. are not shown in detail but may be involved with the receipt of user input and/or presentation of output.

The processes referred to herein may be implemented by processor 604 executing appropriate sequences of computer-readable instructions contained in main memory 606. Such instructions may be read into main memory 606 from another computer-readable medium, such as storage device 610, and execution of the sequences of instructions contained in the main memory 606 causes the processor 604 to perform the associated actions. In alternative embodiments, hard-wired circuitry or firmware-controlled processing units (e.g., field programmable gate arrays) may be used in place of or in combination with processor 604 and its associated computer software instructions to implement the invention. The computer-readable instructions may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying” or the like, refer to the action and processes of an appropriately programmed computer system, such as computer system 500 or similar electronic computing device, that manipulates and transforms data represented as physical (electronic) quantities within its registers and memories into other data similarly represented as physical quantities within its memories or registers or other such information storage, transmission or display devices.

Computer system 600 also includes a communication interface 618 coupled to the bus 602. Communication interface 618 provides a two-way data communication channel with a computer network, such as network 130 in FIG. 1, which provides connectivity to and among the various servers discussed above. For example, communication interface 618 may be a local area network (LAN) card to provide a data communication connection to a compatible LAN, which itself is communicatively coupled to the Internet through one or more Internet service provider networks. The precise details of such communication paths are not critical to the present invention. What is important is that computer system 600 can send and receive messages and data through the communication interface 618 and in that way communication with hosts accessible via the Internet.

The various databases described herein are computer-based record keeping systems. Stated differently, these databases are each a combination of computer hardware and software that act together to allow for the storage and retrieval of information (data). Accordingly, they may resemble computer system 600, and are often characterized by having storage mediums capable of accommodating significant amounts of information.

FIG. 6B illustrates a computer system 600 from the point of view of its software architecture. Computer system 600 may be server 120 referred to above or, with appropriate applications comprising a software application layer 632, may be a client system or one of the host servers for a Web site.

The various hardware components of computer system 600 are represented as a hardware layer 620. An operating system 622 abstracts the hardware layer and acts as a host for various applications 624a-624m, that run on computer system 600. In the case of server 120, the operating system acts as a host for a matching and decision engine 626, which is configured to perform the processes described above (e.g., to provide creative selections and insertions or other actions). For a server 102 and/or 108, the operating system may host a web server application 628, which provides access from the client computers via web browsers. Such a web server may also be hosted on server 120 to provide an interface by which the host servers 102 and 108 may communicate with server 120. In the case of a client system, the operating system acts as a host for a Web browser application 632, but not a matching and decision engine or (typically) a web server.

As alluded to above, network 130 may include the Internet and the various servers and client computers communicatively coupled thereto may include computer systems, such as computer system 600, that are made up of one or more processors, associated memory (typically volatile and non-volatile) and other storage devices and peripherals that allow for connection to the Internet or other networks. The precise hardware configuration of the hosting and client resources is generally not critical to the present invention, nor are the precise algorithms used to implement the services and methods described herein. Instead, the focus is on the nature of the services provided by the present invention.

Thus, methods and systems for automatically analyzing on-line conversations or similar discourses among individuals and determining through such analyses outcomes of the conversations as evidenced, for example, by expressions of sentiment during the conversation, have been described. The present invention examines the interaction between participants in a conversation through the lens of intention in order to infer sentiment. Certain intentions may be highly indicative of sentiments; for example, a statement of a problem may be highly indicative of displeasure while an expression of gratitude may be highly indicative of a positive experience. As conversations continue, the analysis of later posts may be used to inform decisions regarding earlier posts. For example, if an initial post is determined to be actionable, but the sentiment of that post cannot readily be resolved, that sentiment may be updated when a later post by a brand is recognized as an apology—indicating the contact's original post was somehow expressing a problem or dissatisfaction with a situation. This information can be used to update the models used during the post and overall conversation analyses in order to provide better future results.

The present invention is especially useful in the context of on-line call centers and the like where customer service agents are interacting with consumers in a variety of contexts. Of course, the invention may also find application in other contexts, for example where ever it is useful to make automated determinations of sentiment based on text. The text may be postings to on-line venues, such as those discussed above, or may be later-provided or simultaneous transcripts of live conversations. In some cases, the present invention can be applied to focus group analyses by reducing conversations between focus group members and/or interviewers to text and analyzing the text in accordance with the above-described methods.

In various embodiments of the invention where creative are used either as suggestions or direct posts, the decision process may also incorporate learning based on past experiences with the creatives. For example, user interaction with previous instances of the creatives when inserted into Web pages may be tracked and used when deciding which, if any, creatives to provide for insertion. Moreover, such experience may be used in the matching process when deciding which introductions, calls to action and other components to combine with one another to form a creative. Further, features or metrics regarding the conversation, such as conversational velocity, may be monitored and used as a guide for deciding whether and when to respond to a post. Such functions may be incorporated in the matching and decision engine, as appropriate.

Of course, intention type and topic as determined by the present methods and systems may be used to create, augment, inform or otherwise include or interact with one or more user profiles. Such profiles may be fashioned over a period of time in order to develop a more complete understanding of a particular user, which understanding may be used to determine which advertisements to present to the user and when to present them, what methods to employ in dealing with a particular customer's complaints, etc.

Given the various instances in which the present systems and methods find application, it should be recognized that the examples presented in the foregoing description were provided merely for purposes of illustration and should not be read as unduly limiting the present invention.

What is claimed is:

1. A computer-implemented method, comprising analyzing, by a matching and decision engine, a text-based form of a conversation carried on between at least two participants, the conversation being characterized by posts from each participant, to extract an intention type and intention topic of utterances contained within one or more of the posts; on the basis of the intention type and intention topic, inferring sentiment of each post; and, on the basis of sentiments inferred for multiple ones of the posts, determining an outcome of the conversation.

2. The method of claim 1, wherein at least some of the posts comprise user generated content (UGC) presented via a network-enabled platform.

3. The method of claim 2 wherein candidate creatives for responsive posts during the conversation are suggested based upon assessments of the intention type and intention topic from the UGC.

4. The method of claim 1, wherein those conversations determined to originate with posts comprising actionable intentions are selected for responses.

5. The method of claim 4, wherein if a response to an actionable post is not recognized within a predetermined time period, the conversation is determined to be a missed opportunity.

6. The method of claim 4, wherein if a problem recognized from an actionable post is not deemed to be resolved during the conversation, the conversation is determined to have a negative outcome.

7. The method of claim 4, wherein if a problem recognized from an actionable post is deemed to be resolved during the conversation, the conversation is determined to have a positive outcome.

8. The method of claim 4, wherein sentiments determined with respect to prior posts during the conversation are updated on the basis of information determined from analysis of later posts during the conversation.

9. The method of claim 1, wherein the conversation is modeled on the basis of business rules that define transition states within the model, the states being associated with a party having the initiative in the conversation.

10. The method of claim 1, wherein sentiments derived from analyses of intentions in the posts comprising the conversation are used to update a user profile.

11. A computer-implemented method, comprising determining an outcome of a conversation by analyzing one or more text-based representations of at least portions of posts by participants in the conversation and, based thereon, inferring positive or negative affinity for a brand associated with the conversation.

12. The method of claim 11, wherein at least some of the posts comprise user generated content (UGC) presented via a network-enabled platform.

13. The method of claim 12 wherein at least some of the posts comprise candidate creatives suggested based upon assessments of intention type and intention topic derived from the UGC.

14. The method of claim 11, wherein only those conversations determined to originate with posts comprising actionable intentions are selected for responses.

15. The method of claim 14, wherein actionability of a subject post is determined on the basis of the subject post, a tokenized representation of the subject post and a determined intention topic of the subject post.

16. The method of claim 13, wherein candidate creative are selected according to a determined relevance thereof, said relevance assessed on the basis of a determined intention topic of a subject post and a determined intention type of the subject post.
